(19) United States
(12) Patent Application Publication
(10) Pub. No.: US 2017/0043724 A1
(43) Pub. Date: Feb. 16, 2017

(54) CAR-USE ARTICLE HOLDING DEVICE

(71) Applicant: RUNG-HUA CHEN, Hsinchu County (TW)

(72) Inventor: RUNG-HUA CHEN, Hsinchu County (TW)

(21) Appl. No.: 14/826,322

(22) Filed: Aug. 14, 2015

(51) Int. Cl. B60R 7/04; B60R 11/00; B60R 7/08

(52) U.S. Cl. CPC B60R 7/04; B60R 7/084; B60R 11/00; B60R 2011/005

(57) ABSTRACT

A car-use article holding device includes primarily a holding element, a supporting element and an assembling element. The holding element is provided with an opening and a holding space which is concaved inward from the opening. The supporting element is provided with a top part and an opposite bottom part. The assembling element is disposed between the holding element and the supporting element to fix the supporting element below the holding element. The holding space of the holding element provides for a user to emplace an article, such as a tissue box. The supporting element can be disposed at a cup holder in a car. By the assembling element, the holding element is combined with the supporting element, and the height of the entire supporting element is adjustable, thereby enabling the holding device to be applied to a cup holder in a various depth.

### BACKGROUND OF THE INVENTION

### (a) Field of the Invention

The present invention relates to a car-use article holding device, and more particularly to an article holding device which can be fixed at a cup holder in a car, allowing a user to emplace an article such as a tissue box.

### (b) Description of the Prior Art

The living standard of modern society improves rapidly, so that all kinds of automobile, including SRV (Sport Utility Vehicle), passenger car, freight car and truck, have been increasingly popular following the needs of work and traveling, and thus have become indispensable transportation vehicles for modern human being. However, for the existing cup holder used in a vehicle, the design takes a certain diameter and depth that the shape, size of space and depth are limited when emplacing an article. Therefore, the cup holder can only provide for emplacing a cup or small article and is unable to provide for emplacing an article in other shape properly.

If an article in a car, such as the most commonly used tissue box, has no proper fixed location to be emplaced, then a driver will usually put it in all places in the car, for example, the front passenger seat, above the dashboard or other places. This not only messes up the space in the car that the article will roll and fall easily when the car is accelerating, decelerating or turning, but also causes a trouble that the article cannot be reached easily or is put too far to access. In particular, as the driver will have to search for the article when driving the car, he or she can be distracted easily to result in a traffic accident.

### SUMMARY OF THE INVENTION

Accordingly, the primary object of the present invention is to provide a car-use article holding device which can be fixed at a cup holder in the car, allowing the user to emplace an article, such as a tissue box.

To achieve the abovementioned object, the car-use article holding device, the present invention, includes at least a holding element, a supporting element and an assembling element. The holding element is provided with an opening and a holding space which is concaved inward from the opening. The supporting element is provided with a top part and an opposite bottom part. The assembling element is between the holding element and the supporting element to connect the supporting element to the holding element. The assembling element is provided with a first screwing element and a second screwing element; the first screwing element is at the bottom of the holding element and the second screwing element is at the top of the supporting element.

The holding space of the holding element provides for the user to emplace an article (such as a tissue box), and the supporting element can be emplaced at the cup holder in the car. In addition, by the assembling element, the holding element is combined with the supporting element and the height of the entire device is adjustable, enabling this invention to be applied to the cup holder in a various depth.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural exploded view of an article holding device, according to the present invention.

FIG. 2 shows a structural schematic view of the article holding device, according to the present invention.

FIG. 3 shows a schematic view of a first implementation of the article holding device, according to the present invention.

FIG. 4 shows a schematic view of a second implementation of the article holding device, according to the present invention.

FIG. 5 shows a structural exploded view of the article holding device from another view angle, according to the present invention.

### DETAILED DESCRIPTION OF THE PREFERRED EMBODIMENTS

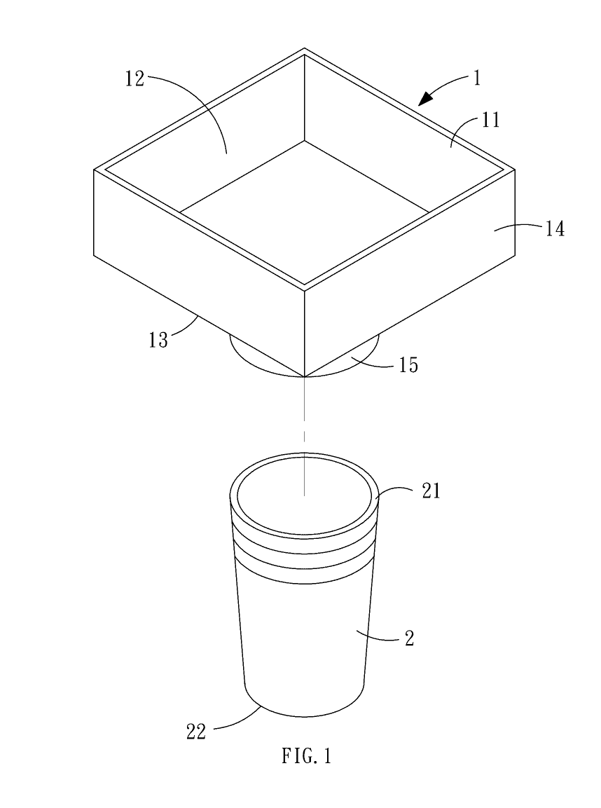

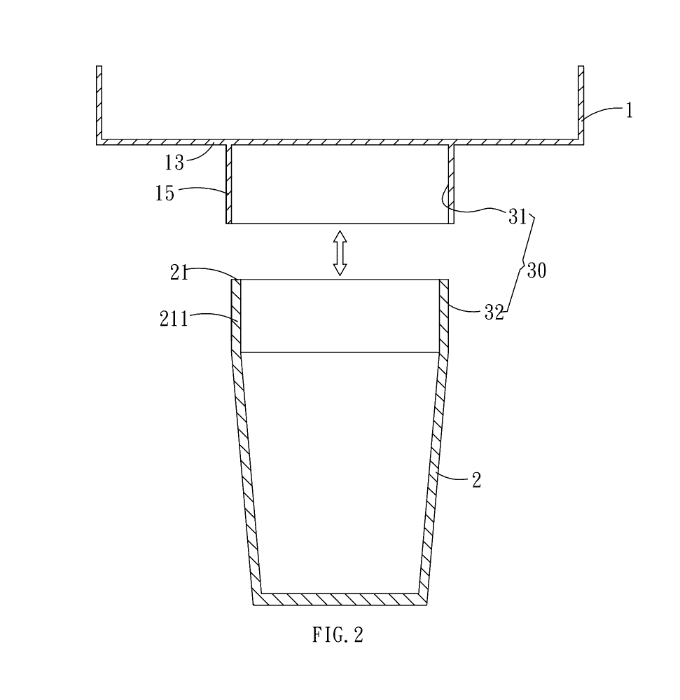

FIG. 1 shows a structural exploded view of an article holding device, according to the present invention; whereas, FIG. 2 shows a structural schematic view of the article holding device, according to the present invention. The article holding device of the present invention comprises primarily a holding element 1, a supporting element 2, and an assembling element 30.

The holding element 1 is provided with an opening 11 and a holding space 12 which is concaved inward from the opening 11. As the embodiment shown in the drawings, the holding element 1 can be a square sink structure and is provided with a closed bottom surface 13 opposite to the opening 11, and a border 14 which is connected to the bottom surface 13 and the opening 11. The bottom surface 13 of the holding element 1 is provided with an extension part 15 and the holding element 1 can be made of metal or plastic; whereas, the color of the holding element 1 can be changed according to the user's need. In addition, the holding element 1 can be also a cylindrical structure.

The supporting element 2 is provided with a top part 21 and an opposite bottom part 22 and can be made of metal or plastic; whereas, the color of the supporting element 2 can be changed according to the user's need. A uniform cylindrical part 211 is disposed close to the top part 21 of the supporting element 2, as shown in FIG. 2. On the other hand, the width of the supporting element 2 decreases gradually from the bottom of the cylindrical part 211 to the bottom part 22 of the supporting element 2.

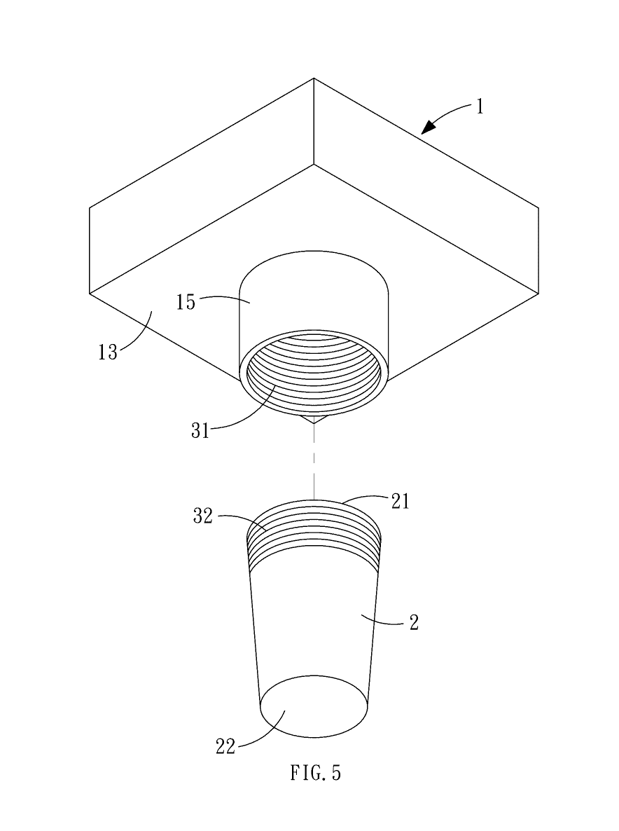

The assembling element 30 is disposed between the holding element 1 and the supporting element 2 to fix the supporting element 2 below the holding element 1. Referring to FIG. 2 and FIG. 5 at a same time, the assembling element 30 is provided with a first screwing element 31 and a second screwing element 32. The first screwing element 31 is disposed at the extension part 15 of the holding element 1, and the second screwing element 32 is disposed at the top part 21 of the supporting element 2. As the embodiment shown in the drawings, the second screwing element 32 is disposed at the cylindrical part 211 of the supporting element 2, wherein the extension part 15 and the supporting element 2 can be a cylindrical structure, and the width of the extension part 15 can be a little larger than that of the top part 21 of the supporting element 2. The first screwing element 31 is an inner thread and is disposed on an inner wall of the extension part 15; whereas, the second screwing element 32 is a corresponding outer thread and is disposed on an outer wall close to the top part 21. By engaging the first screwing element 31 with the second screwing element 32, the supporting element 2 can be fixed below the holding element 1. The primary effect of the present invention is that by the height at which the first screwing element 31 is engaged with the second screwing element 32, the height at which the supporting element 2 is fixed at the extension part 15 can be changed, thereby adjusting the height of the entire supporting element 2, then, the height of the entire holding device. As such, the article holding device can be applied to the cup holder in a various depth.

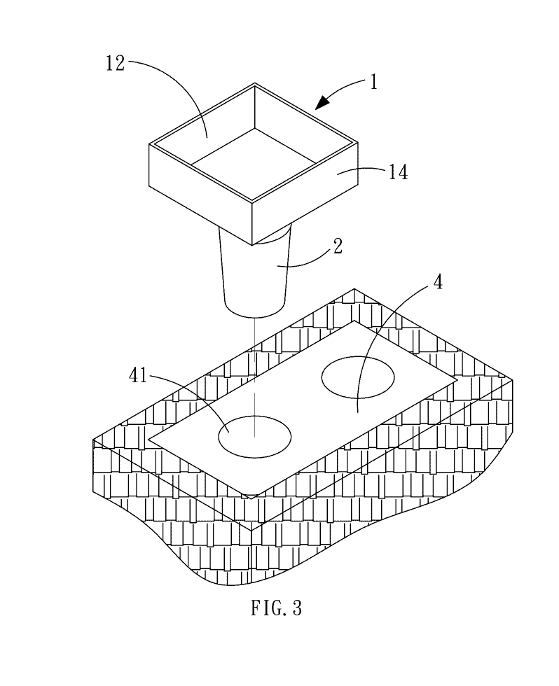

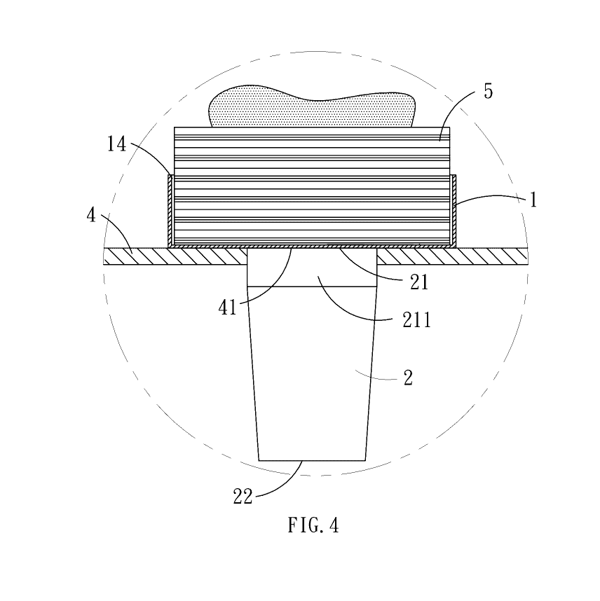

When the entire device is used, the supporting element 2 is fixed below the holding element 1, as shown in FIG. 3 and FIG. 4. Next, the supporting element 2 is sheathed into a through-hole 41 of a cup holder 4 in the car. At this time, the characteristic that the decreasing width of the supporting element 2 can be utilized to lock the holding element into the cup holder 4, thereby can achieve the effect of positioning. In addition, by the height at which the first screwing element 31 is engaged with the second screwing element 32, the height at which the supporting element 2 is fixed at the extension part 15 can be changed to adjust the height of the entire supporting element 2, such that the article holding device can be located at a cup holder where it is used conveniently.

As shown in FIG. 3 and FIG. 4, the holding space 12 of the holding element 1 provides for the user to emplace an article 5 (such as a tissue box). The article holding device of the present invention can be applied to a cup holder in a various specification in all kinds of vehicle, without a need to damage an interior panel of the vehicle, so that the article in the vehicle can be positioned conveniently, allowing the user to take and emplace the article in the car easily, thereby maintaining safe driving.

It is worthy of mentioning that the assembling element of the present invention facilitates the dismantlement and combination of the holding element and the supporting element, allowing the user to assemble and replace the holding element in a various shape or size by a single supporting element, which further meets the requirement of variety of use.

Accordingly, the present invention discloses a preferred and feasible car-use article holding device and therefore an application of invention patent is filed by law. It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A car-use article holding device, comprising:
a holding element, the holding element being provided with an opening and a holding space which is concaved inward from the opening;
a supporting element, the supporting element being provided with a top part and an opposite bottom part; and
an assembling element, the assembling element being disposed between the holding element and the supporting element to fix the supporting element below the holding element, the assembling element being provided with a first screwing element and a second screwing element, the first screwing element being disposed at the holding element, and the second screwing element being disposed at the supporting element.

2. The car-use article holding device, according to claim 1, wherein the width of the holding element is larger than that of the supporting element.

3. The car-use article holding device, according to claim 1, wherein a uniform cylindrical part is disposed close to the top part of the supporting element. And the width of the supporting element decreases gradually from the bottom of the cylindrical part to the bottom of the supporting element.

4. The car-use article holding device, according to claim 3, wherein the second screwing element is disposed at the cylindrical part of the supporting element.

5. The car-use article holding device, according to claim 1, wherein a bottom surface of the holding element is provided with an extension part, and the first screwing element is disposed at the extension part of the holding element.

6. The car-use article holding device, according to claim 1, wherein a bottom surface of the holding element is provided with an extension part.

7. The car-use article holding device, according to claim 6, wherein the first screwing element is disposed at the extension part of the holding element.

8. The car-use article holding device, according to claim 1, wherein the second screwing element is disposed at the top part of the supporting element.
